(19) United States
(12) Patent Application Publication
(10) Pub. No.: US 2006/0010322 A1
(43) Pub. Date: Jan. 12, 2006

(54) Record management of secured email

(75) Inventors: Brian M. Novack, St. Louis, MO (US); Daniel Larry Madsen, Castro Valley, CA (US); Michael David Cheaney, Arnold, MO (US); Timothy R. Thompson, St. Louis, MO (US); Andrea Wilemon, Livonia, MI (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Austin, TX (US)

(21) Appl. No.: 10/887,807

(22) Filed: Jul. 12, 2004

(51) Int. Cl. H04L 9/00

(52) U.S. Cl. 713/170

(57) ABSTRACT

Email can be securely stored using a secure record management system. An encrypted email is received at the secure record management system. The received email is a duplicated copy of a transmitted email and is decryptable by the secure record management system. The received email is processed and providing to an archive for archiving.

### BACKGROUND OF THE INVENTION

1. Field of the Invention

The present invention relates to electronic communications. More particularly, the present invention relates to securely archiving and managing electronic communications.

2. Background Information

A need exists to securely archive and manage electronic communications. Currently, unencrypted or otherwise unsecured electronic communications may be copied and archived. However, the origin and authenticity of electronic communications cannot be verified when the electronic communications are unencrypted or otherwise unsecured. For example, unencrypted or otherwise unsecured electronic communications that are archived are subject to doubt as to origin and content.

To remove doubt as to origin and content, an escrow system is known which receives encrypted electronic communications transmitted directly from an email client. However, the escrow system is intentionally not provided with a decryption key for the encrypted electronic communications. Therefore, the escrow system can only store, and not process or otherwise manage, the encrypted electronic communications.

Additionally, as a management tool, an entity such as an employer or service provider may copy electronic communications for multiple authors as the electronic communications are sent and/or received by each author. The electronic communications are stored in a storage without being processed or otherwise managed by a record management system. When the copied electronic communications are encrypted, the encryption employed for each author varies, and the decryption keys are not provided with the copied electronic communications. Accordingly, even if the entity wants to process or otherwise manage the electronic communications prior to storage, the encrypted electronic communications cannot be processed or otherwise managed. Furthermore, when stored electronic communications vary by the encryption (if any) employed for each author, the electronic communications of multiple authors are difficult to process, search, analyze, monitor and otherwise manage. For example, because the electronic communications are not decrypted (if encrypted) and processed before being archived, the format and varying encryption among the archived electronic communications makes them virtually impossible to search. Accordingly, even if the entity wants to manage the stored electronic communications, the encrypted electronic communications cannot be managed.

As a result, an entity cannot process or otherwise manage encrypted electronic communications for multiple authors. Alternatively, the entity accepts a security risk when unencrypted or otherwise unsecured communications are archived and managed for multiple authors. In the former circumstance, the entity would incur prohibitive costs, such as employee time or computing resources, in attempting to process or otherwise manage encrypted information for multiple authors. In the latter circumstance, the entity incurs significant risk of liability, such as the loss of trade secret information, that expands with the amount of unsecured information being archived and managed.

As described above, an entity may wish to archive data for multiple users or authors in a manner that provides assurance of the sources and content at a later time. However, the entity may wish to process and otherwise manage the data before archiving to ensure the data can be searched, analyzed, monitored and otherwise managed.

Accordingly, a need exists to archive and manage electronic communications using a secure record management system. A need exists to provide electronic communications to the secure record management system in a format that is decryptable by the secure record management system, so that the electronic communications can be archived and managed.

To solve the above-described problems, a method and apparatus are provided for record management of secured email.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawing, and in which:

FIG. 1 shows an exemplary computer network for record management of secured email, according to an aspect of the present invention;

FIG. 2 is an exemplary record management system and archive for record management of secured email, according to an aspect of the present invention;

FIG. 3 is an exemplary email client for record management of secured email, according to an aspect of the present invention;

FIG. 4 is an exemplary flow diagram showing a method of providing a received email to a record management system, according to an aspect of the present invention;

FIG. 5 is an exemplary flow diagram showing a method of providing a sent email to a record management system, according to an aspect of the present invention;

FIG. 6 is an exemplary flow diagram showing a method of cataloging an email for archiving, according to an aspect of the present invention;

FIG. 7 is an exemplary flow diagram showing a method of analyzing and retrieving archived emails, according to an aspect of the present invention; and

FIG. 8 is an exemplary graphical user interface for entering information to search for archived emails, according to an aspect of the present invention.

### DETAILED DESCRIPTION OF THE INVENTION

In view of the foregoing, the present invention, through one or more of its various aspects, embodiments and/or specific features or sub-components, is thus intended to bring out one or more of the advantages as specifically noted below.

According to an aspect of the present invention, a method is provided for securely storing email using a secure record management system. The method includes receiving an encrypted email at the secure record management system. The received email is a duplicated copy of a transmitted email and is decryptable by the secure record management system. The method also includes processing the received email and providing the processed email to an archive for archiving.

According to another aspect of the present invention, the method includes decrypting the received email to obtain the transmitted email.

According to yet another aspect of the present invention, the method includes receiving, from a requester, a request to retrieve emails that match a searchable parameter. The method also includes searching the archive for emails that match the searchable parameter, and retrieving from the archive at least one email that matches the searchable parameter.

According to still another aspect of the present invention, the method includes generating information that identifies the received email.

According to an aspect of the present invention, a secure record management system is provided for securely storing email. The system includes an email receiver that receives an encrypted email. The received email is a duplicated copy of a transmitted email and is decryptable by the secure record management system. The system also includes an email processor that processes the received email. The secure record management system provides the processed email to an archive for archiving.

According to another aspect of the present invention, the system also includes a decryptor that decrypts the received email to obtain the transmitted email.

According to yet another aspect of the present invention, the system also includes a secure interface that receives, from a requestor, a request to retrieve emails that match a searchable parameter. The system also includes a search engine that searches the archive for emails that match the searchable parameter and that retrieves from the archive at least one email that matches the searchable parameter.

According to still another aspect of the present invention, the system also includes an information generator that generates information that identifies the received email.

According to an aspect of the present invention, a computer readable medium is provided for securely storing email using a secure record management system. The computer readable medium includes an email receiving code segment that receives an encrypted email at the secure record management system. The received email is a duplicated copy of a transmitted email and is decryptable by the secure record management system. The computer readable medium also includes a processing code segment that processes the received email and a providing code segment that provides the processed email to an archive for archiving.

According to another aspect of the present invention, the computer readable medium also includes a decrypting code segment that decrypts the received email to obtain the transmitted email.

According to yet another aspect of the present invention, the computer readable medium also includes a request receiving code segment that receives, from a requester, a request to retrieve emails that match a searchable parameter. The computer readable medium also includes an archive searching code segment that searches the archive for emails that match the searchable parameter and that retrieves from the archive at least one email that matches the searchable parameter.

According to still another aspect of the present invention, the computer readable medium also includes an information generating code segment that generates information that identifies the received email.

According to an aspect of the present invention, a method is provided for securely storing email using a secure record management system. The method includes encrypting a duplicated copy of a transmitted email. The method also includes sending the encrypted email to the secure record management system. The sent email is decryptable by the secure record management system. The sent email is processed by the secure record management system. The processed email is provided to an archive for archiving.

According to another aspect of the present invention, the sent email is decrypted by the secure record management system to obtain the transmitted email.

According to yet another aspect of the present invention, the archive is searched for emails that match a searchable parameter, in response to receiving, from a requester, a request to retrieve emails that match the searchable parameter. At least one email that matches the searchable parameter is retrieved from the archive.

According to an aspect of the present invention, an email client is provided that sends emails to a record management system for secure records storage. The email client includes an email encryptor that encrypts a duplicated copy of a transmitted email. The email client also includes an email sender that sends the encrypted email to the secure record management system. The encrypted email is decryptable by the secure record management system. The sent email is processed by the secure record management system and provided to an archive for archiving.

According to another aspect of the present invention, the sent email is decrypted by the secure record management system to obtain the transmitted email.

According to yet another aspect of the present invention, a search engine of the secure record management system searches the archive for emails that match a searchable parameter, in response to receiving, from a requestor, a request to retrieve emails that match the searchable parameter. At least one email that matches the searchable parameter is retrieved.

According to an aspect of the present invention, a computer readable medium is provided for securely storing email using a secure record management system. The computer readable medium includes an encrypting code segment that encrypts a duplicated copy of a transmitted email. The computer readable medium also includes a sending code segment that sends the encrypted email to the secure record management system. The encrypted email is decryptable by the secure record management system. The sent email is processed by the secure record management system and provided to an archive for archiving.

According to another aspect of the present invention, the sent email is decrypted by the secure record management system to obtain the transmitted email.

According to yet another aspect of the present invention, a search engine of the secure record management system searches the archive for emails that match a searchable parameter, in response to receiving, from a requestor, a request to retrieve emails that match the searchable parameter. At least one email that matches the searchable parameter is retrieved.

Multiple computers communicate over a network. A computer may be any device having a processor and a communications interface for communicating electronically with other devices over the network. The network may be of any type that enables communications between the computers, including a local area network (LAN) or a wide area network (WAN).

Security must be assured for communications to and from a computer. Additionally, a record must be kept of communications to and from the computer. The records must be kept in a manner that provides the greatest assurance of the reliability of the sources and content. Therefore, unencrypted and decrypted communications are copied by an email client. For example, communications that are received encrypted, are decrypted and then copied in the decrypted format. The encryption for the received encrypted communications varies by author, and may be decryptable only by a specified recipient. Accordingly, received encrypted communications are copied only once they are decrypted by the recipient. Received communications that are unencrypted do not need to be decrypted, and are copied in the unencrypted format. Communications to be sent from the computer are copied before being encrypted, if they are to be encrypted at all.

The copied unencrypted or decrypted communications are then encrypted by the email client in a format that can be decrypted by a record management system. For example, the copied communications can be encrypted using a public key of a public key/private key pair issued to the record management system. The encrypted communications are provided to the record management system. The communications records are processed by the record management system and archived in an external archive. The communications records may be archived in either a decrypted or encrypted format because even encrypted communications records can be decrypted at any time by the record management system. The record management system provides secure and efficient access to reliable communications records so that the communications records can be managed as needed.

Therefore, when communications are transmitted to or from a computer, the communications are copied, in an unencrypted or decrypted format, as a communications record. The communications records are encrypted to ensure security. Further, the communications records are provided to a record management system. However, the communications records are decryptable by the record management system so that the communications records can be processed and otherwise managed by the record management system. Any form of encryption may be used, so long as the communications records are decryptable by the record management system. As an example, the encryption may use a public/private key pair of a public key infrastructure (PKI).

In an embodiment using public key infrastructure, a digital certificate is issued to the record management system by a certification authority (CA). The public key infrastructure (PKI) uses cryptography and digital signatures to ensure the security and authenticity of communications between computers in the network. An exemplary digital certificate complies with ITU-T Recommendation X.509.

Public key infrastructure uses key pairs of a private key and a public key. The digital certificate asserts that a certain public key is bound to a “subject” of the certificate, i.e., the record management system. The public key is made available to the computer by the record management system. The private key is held securely by the record management system. The public key and private key are mathematically related so that a message encrypted using the private key may be decrypted using the public key, and vice versa.

Using encryption, the copies of electronic communications are securely forwarded from the computer to the record management system as communications records. The communications records are decryptable by the record management system to ensure the content of the communications records can be managed by the record management system as necessary. The communications records can be securely archived in an archive in either encrypted or decrypted form.

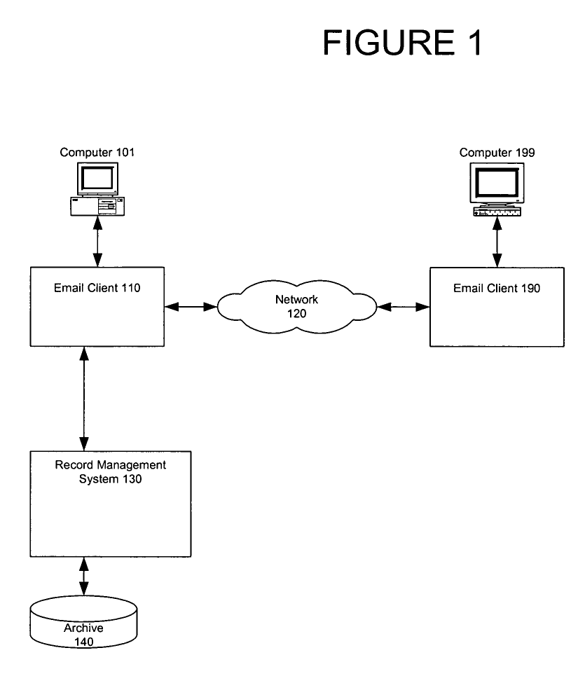

FIG. 1 shows an exemplary computer network for record management of secured email. As shown, a computer 101 and a computer 199 communicate over a network 120. An email client 110 is provided for the computer 101 to send email over the network 120. Additionally, an email client 190 is provided for the computer 199 to send mail over the network 120. As an example, the email clients 110, 190 may be programs that allow the user to view emails temporarily stored on the computers 101, 199 respectively.

Exemplary email clients are the Microsoft Office Outlook and the Microsoft Office Outlook Express programs from Microsoft Corporation of Redmond, Wash. Such email clients 110, 190 are typically, though not necessarily, installed on a computer 101, 199. For example, the email clients 110 and 190 are installed on a computer 101, 199, and may each interact with an email server that coordinates email service in a network. Alternatively, such email clients 110, 190 may be applications provided by the email server to the computers 101, 199.

An email server may be provided by an employer for employees or by a service provider for clients and customers. Multiple computers 101 and/or computers 199 may access a single email server to download or upload emails routed across the network 120.

The computer 101 and the computer 199 may be computers of different employers that provide such computers to employees. A computer 101 and/or a computer 199 may be any type of device that includes a processor and a communications interface for communicating over the network 120. As examples, the computer 101 and/or the computer 199 may be a personal digital assistant (PDA), a personal computer (PC), a handheld computer, a desktop computer, a laptop computer, a notebook computer, a mini computer, a workstation, a mainframe computer, or any other type of device that includes a processor and a communications interface for communicating over the network 120. Additionally, the network 120 may be a network or combination of networks, including wireline networks, wireless networks, or a combination of wireline and wireless networks. As an example, the network 120 may be a local area network (LAN), or a combination of bridged local area networks that form a wide area network (WAN).

The record management system 130 is provided separate from the email client 110. In an embodiment, the record management system 130 is provided on a separate device that is connected to the computer 101 through a local network or through the network 120. The email client 110 generates copies of emails transmitted between the computer 101 and the computer 199. The copies of the transmitted emails are made either for unencrypted emails or when received encrypted emails are decrypted for the specified recipient. The copies of unencrypted emails may be copies of either received unencrypted emails or unencrypted emails that are to be encrypted for transmission and sent. For unencrypted emails that are to be encrypted for transmission and sent, the email client 110 generates the copy before the encryption for transmission. The copies of the unencrypted or decrypted emails are encrypted and provided to the record management system 130 for management. The copies are decryptable by the record management system 130. The copies of emails are archived in the archive 140 where they can be searched and retrieved as needed.

In an embodiment, a public/private key pair with a digital certificate is issued to the record management system 130. As an example, a digital certificate may comply with a digital certificate protocol such as the X.509 protocol.

The public key of the digital certificate is provided by the record management system 130 to the computer 101 or server supporting the email client 110. Using the public key, copies of emails provided by the computer 101 to the record management system 130 can be encrypted. According to an aspect of the present invention, emails to or from the computer 101 are copied, encrypted using the public key of the record management system 130, and sent to the record management system 130.

When an entity with multiple computers 101 has email managed by the record management system 130, the entity may need to search the emails of all of the computers 101 using such computers. Accordingly, the client 110 only encrypts the copied emails using the public key of the record management system 130. As a result, while the users of individual computers 101 lose the ability to ensure that the record management system 130 cannot alter the archived emails, the record management system 130 can process, search and otherwise manage the emails of numerous computers using a single encryption key. Of course, the record management system 130 need not be an external service. Rather, the record management system 130 may be a component on the same local network as the individual computers 101. However, the record management system 130 itself should be trusted by the entity providing the computer 101 when the record management system 130 is an external service.

In the embodiment of FIG. 1, the record management system 130 may decrypt the email for archiving and management. Alternatively, the record management system 130 associates the encrypted email with unencrypted information, such as the identities of the sender and recipient, and provides the encrypted email and the associated information to the archive 140 (or any other suitable form of memory) for archiving and management. The emails may be cataloged by title, content, the sender's information, the recipient's information, the time the email was sent and received, or any other similar information associated with the email. The cataloged email information can be easily searched and recovered when necessary. For example, the email information can be searched by subject, the information of the sender or recipient, the time of receipt, the entity associated with the sender and/or recipient, attachments to the emails, the priority of the emails, or any other information typically associated with emails. When the emails are archived in the encrypted format, the record management system 130 may need to decrypt numerous emails to search for particular content. However, if the emails being sought are identified by sender, recipient, transmission time etc., the emails may be identified even though the content itself has never been decrypted.

In an embodiment, the emails are managed to support policies and procedures of a client of the record management system 130. For example, the record management system 130 may manage email service to ensure that users are not using the entity's computers inappropriately. In this regard, the emails may be analyzed to ensure that users are not receiving emailed pornography, not disclosing confidential trade secret information, not otherwise engaging in illegal behavior or otherwise abusing the entity's resources. Of course, when an analysis determines that a computer is being used inappropriately to send or receive inappropriate emails, the entity can be informed so that action can be taken.

An administrator can monitor the email information archived in the archive 140. For example, the administrator can periodically request that the record management system 130 search the emails stored in the archive 140 for emails that match specified criteria. Accordingly, using the record management system 130 and the archive 140, the administrator can monitor the archived email information from time to time.

The management of emails may also be performed live, as they are received, regardless of whether the emails are to be cataloged and archived in the archive 140. In this regard, an administrator may analyze emails to determine if they are from known spam sites. In the case of spam being received, the emails may be discarded without further management. Of course, the record management system 130 may inform the user of computer 101, or another responsible party, to take action to block further emails from the spam address. The record management system 130 may provide such email analysis as a service for multiple client entities, such as individuals, companies and government agencies.

Accordingly, the record management system 130 can be used to securely transmit and process emails for processing, analysis, categorization, monitoring and other forms of management. The analysis may occur live or after the digital certificate information is cataloged and archived in a predetermined and searchable format. In other words, the record management system 130 and archive 140 provide a client with the ability to securely archive emails without losing the ability to manage the emails as needed.

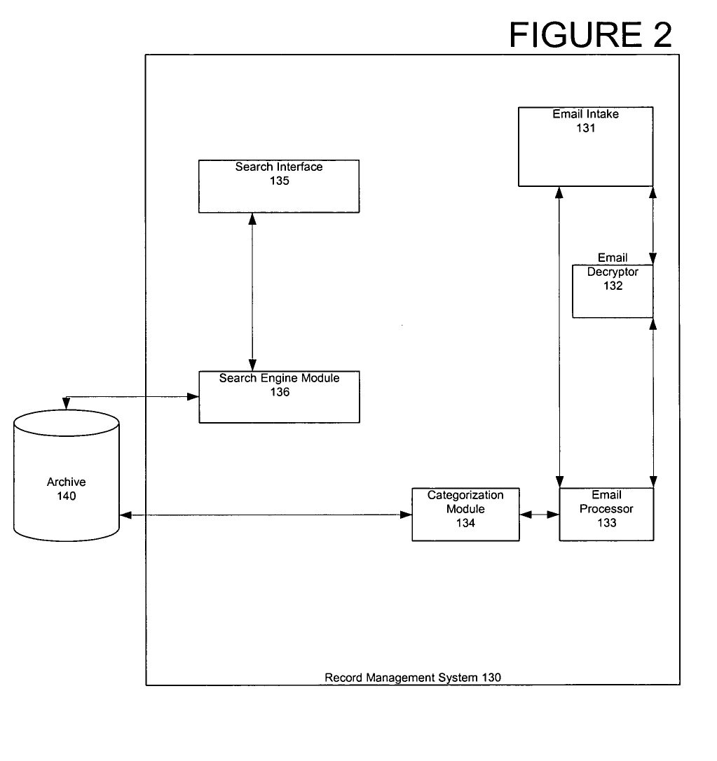

FIG. 2 shows the architecture of an exemplary record management system and archive for record management of secured email. As shown, the record management system 130 includes an email intake 131 that receives emails from an email client 110. When an incoming email is encrypted and is to be decrypted, an email decryptor 132 decrypts the encrypted email and forwards the decrypted email to an email processor 133 that processes incoming emails. If the email is received as plain text by the email intake 131, or if the email is to be left encrypted, the email is forwarded directly to the email processor 133.

The email processor 133 processes and otherwise manages the emails according to criteria determined by the provider of the record management system 130 and/or the email client 110. For example, the email processor 133 may process emails to ensure that they conform to a standard and acceptable format, e.g., text or hypertext markup language (HTML). The email processor 133 may ensure that email content is in a standard and acceptable language, e.g., English. The email processor 133 ensures that the email contents, whether encrypted or unencrypted, are associated with a date and time of receipt, the sender and recipient of the email, any email attachments received with the email, or any other information that could be used later to identify email among multiple emails archived in an archive 140.

Of course, the email processor 133 may also determine that an email should be deleted and delete the email without formatting it for archiving and management. For example, the email processor 133 may determine that an email is spam, or not business related, or not subject to archiving pursuant to the instructions of the client. Accordingly, the email processor 133 may delete an email rather than providing it for archiving and management.

After processing and other management at the email processor 133, the email is categorized at a categorization module 134. The categorization module 134 forwards the categorized email to the archive 140 for storage. The categorization module 134 categorizes emails as directed by the provider of the record management system 130 or a client of the provider of the record management system 130. Alternatively, the categorization module 134 may categorize emails according to predetermined instructions provided in a prepackaged software program, when the categorization module is a prepackaged software module provided for the record management system 130.

A search can be performed using a search interface 135 to retrieve archived emails. In an embodiment, the client or an outside party, e.g., a law enforcement or judicial agency, uses the search interface 135 to request that data or emails related to a specified criteria be found and retrieved. The search interface 135 may be a graphical user interface (GUI) that is downloaded from a server. The search interface 135 can be used to enter search parameters or authorization information to perform a search of archived emails. The formatted search parameters can be used to search the electronic communications data archived by the client directly by comparing the search terms to the content of the archived emails.

When the emails have been categorized by the categorization module 134, the search may be limited to only emails of a particular category. For example, if the record management system 130 manages emails for multiple clients, the search for a particular client is likely to be limited to a category of emails related to only one client.

The information from the search interface 135 is provided to a search engine module 136 that authenticates the request and formats the search parameters. The search engine module 136 may also perform an analysis of the data, according to additional predetermined parameters. For example, the search engine module 136 may analyze retrieved emails and attachments to determine the size and format, and the contents of attachments. The search engine module 136 may also provide summary information such as the number and identity of emails matching the search parameters, so that the emails can be individually selected and retrieved by the party requesting the search. Accordingly, the search engine module 136 performs an analysis to search and retrieve the emails archived in the archive 140.

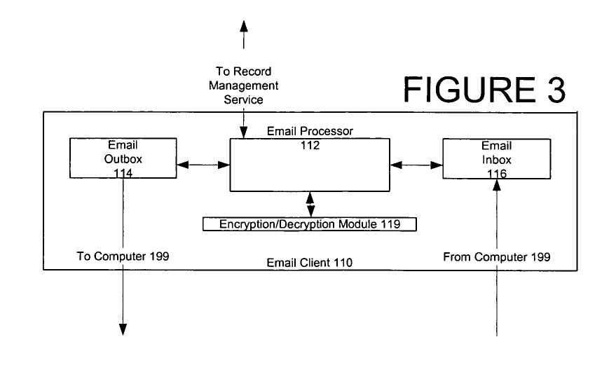

FIG. 3 shows an exemplary email client 110 for record management of secured email. An email client 110 may be an application installed for a user on a computer 101. However, as previously noted, an email client 110 may be a module of an email server. Further, the email client 110 may be a distributed resource that is distributed among multiple computers 101 and/or email servers.

The email client 110 includes an email processor 112 for processing emails before they are sent or after they are received. The email processor 112 includes a set of instructions for processing incoming and outgoing emails. The processing instructions can be customized by the user. For example, the email processor 112 may process an instruction to store an incoming email from a particular address in a specified personal folder of the user. As shown, the email processor 112 processes emails for an email outbox 114 and an email inbox 116.

In this regard, an email received by the email client 110 may have been encrypted using an encryption key issued to either the sender or the recipient of the email. In either case, the email processor 112 determines that the received email has been encrypted and provides the received email to the encryption/decryption module 119 for processing. The encryption/decryption module 119 obtains the appropriate decryption key and decrypts the received email.

The email processor 112 also provides outgoing emails to the encryption/decryption module 119 when the emails need to be encrypted before being sent. The email processor 112 determines that an outgoing email is to be encrypted, and provides the outgoing email to the encryption/decryption module 119 for processing.

The email processor 112 may include instructions to provide all emails, or only a portion of the emails that meet predetermined criteria, to the encryption/decryption module 119. For example, the email processor 112 may determine that a received email is spam, in which case it is automatically deleted and not provided to the encryption/decryption module 119. Additionally, the email processor 112 may determine that an author does not wish to encrypt an outgoing email, in which case it is provided to the email outbox 114 and sent to a recipient.

The email client 110 ensures that received and/or sent emails can be securely archived and managed. Encrypted incoming emails are decrypted by the encryption/decryption module 119. The email processor 112 copies decrypted incoming emails. Of course, unencrypted incoming email do not need to be decrypted by the encryption/decryption module 119. The encrypted received emails that are decrypted by the encryption/decryption module 119 are copied by the email processor 112. Additionally, unencrypted received emails that needed no decryption are copied by the email processor 112. Accordingly, the email processor 112 obtains copies of transmitted emails (i.e., received or sent using the email client 110) that do not vary by the encryption (if any) employed for each author.

The copied emails are then encrypted, using an encryption key assigned to the record management system 130, by the encryption/decryption module 119. The encrypted emails are provided to the record management system 130. Accordingly, the emails provided to the record management system 130 can be archived and/or managed in a consistent format.

The digital certificate of the record management system 130 is used to encrypt copied emails for multiple computers, e.g., all of the computers 101 in a client's local network. The encrypted copies are forwarded to the record management service 130 for archiving and management.

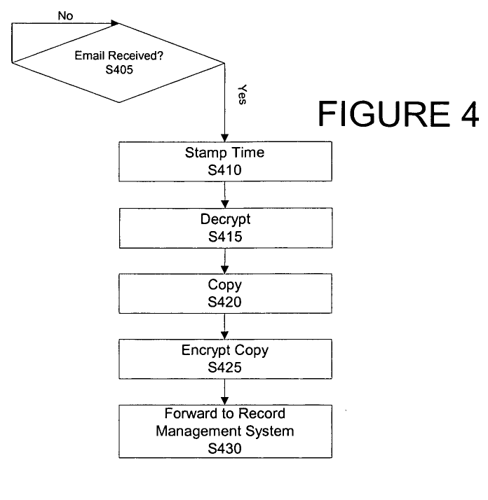

FIG. 4 shows an exemplary flow diagram of a method for providing a received email to the record management system 130. At S405, a determination is made whether an email has been received by the email client 110. If no email has been received (S405=No), the determination is repeated until an email is received by the email client 110. If an email has been received by the email client 110, the date and time are stamped at S410. The time stamp stores the date and time as electronic data with the received email. At S415, the email is decrypted using a decryption key of the email's sender or recipient. At S420, the decrypted email is copied and, at S425, the copied email is encrypted using the public key of the record management system's 130 digital certificate. The email encrypted with the public key of the record management system 130 is forwarded to the record management system 130 at S430 for eventual archiving (when appropriate) and management.

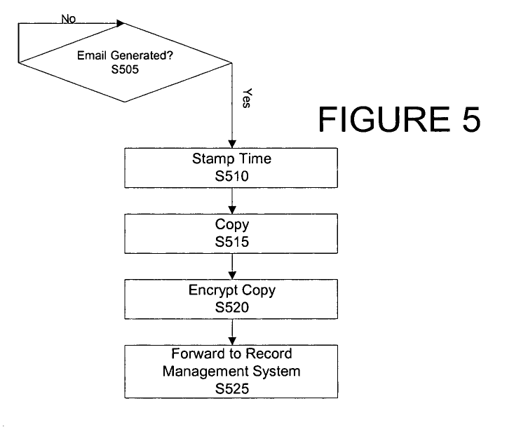

FIG. 5 shows an exemplary flow diagram of a method for providing a sent email to the record management system 130. At S505, a determination is made whether an email has been generated by a user of the email client 110. If no email has been generated by the user (S505=No), the determination is repeated until an email is generated by the user of the email client 110. If an email has been generated by the user of the email client 110, the date and time are stamped at S510. The time stamp stores the date and time as electronic data with the received email. At S515, the new email is copied and, at S520, the copied email is encrypted using the public key of the record management system's 130 digital certificate. The email encrypted with the public key of the record management system 130 is forwarded to the record management system 130 at S525 for eventual archiving (when appropriate) and management.

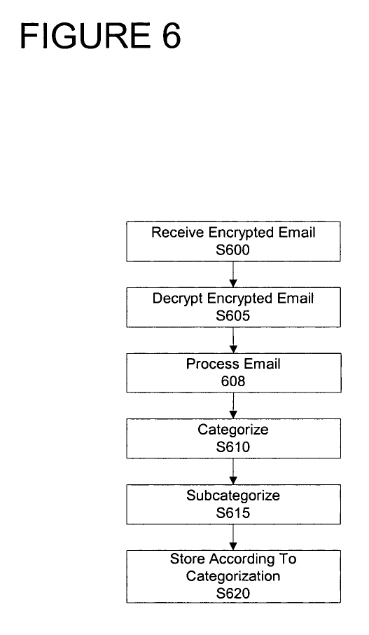

FIG. 6 is an exemplary flow diagram for a method of cataloging an email for archiving. The encrypted email is received by the record management system 130 from the email client 110 at S600. The received email is decrypted at S605, using, e.g., the private key of the record management system 130.

The decrypted email is processed and otherwise managed at S608. For example, the decrypted email may be formatted into an format appropriate for archiving and management. The decrypted email may be evaluated to ensure that it should be archived. Additionally, the decrypted email may be evaluated to ensure that it is in a specified language, or to or from a predesignated party. Accordingly, the decrypted email may be processed to determine whether the decrypted email should be archived, deleted, formatted, translated, or disposed of or treated in any other manner.

At S610, the decrypted email is categorized. The decrypted email may be categorized by an address of the sender or recipient. As an example, emails from one or more email addresses may be grouped together as a category. Multiple coworkers may be grouped in a category because their work communications are likely to relate to similar topics. Alternatively, emails of an entire staff of an employer may be grouped in a single category, separate from emails managed by the record management system 130 for other clients.

The decrypted email may also be categorized according to priority, time, title, or information inserted into the email content as a “flag” for categorization. In this regard, the record management system 130 may be instructed to segregate emails with particular flags into a category for one or more affiliated email clients 110.

The decrypted email is subcategorized at S615. The decrypted email may be categorized by any parameter not used as the primary categorization parameter. For example, if the primary categorization parameter is a domain name of an address of the sender or recipient, the secondary categorization parameter may be a criteria that divides emails by user. Of course, the emails may be categorized and subcategorized according to any distinguishable parameter presented in a decrypted email. The categorized emails are archived at S620.

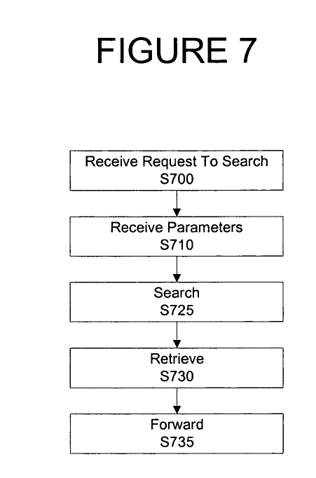

FIG. 7 is an exemplary flow diagram showing a method of analyzing and retrieving archived emails. At S700, the record management system 130 receives a request to search for a particular set of emails. At S710, the record management system 130 receives parameters for the search. For example, the record management system 130 may receive a set of addresses, times and dates, search terms, or any other information that distinguishes emails from one another. The parameters received at S710 are provided by a user via the search interface 135.

In this regard, a law enforcement or judicial authority may contact the record management system 130 with a request or order to search the archived messages for those meeting specified criteria. The search interface 135 may be a component of a web application that can be downloaded from a web server by the requester, in order to access the record management system 130. In another embodiment, the requester contacts a representative of the record management system 130 to have the search performed according to the specified parameters. Of course, the requester may be any person authorized to request or perform searches of data at the record management system 130. For example, the requester may be a representative of the entity that provides the computer 101 to a user.

At S725, the search of the archived emails is performed, and emails are retrieved at S730. As previously noted, the requester specifies parameters for the search, including addresses for the sender and recipient, a time frame, keywords, or any other parameter that can distinguish emails from one another. The search is performed by the search engine module 136. Additionally, a summary of the retrieved emails may be presented to the requester, including a list of emails organized by date, time, sender or recipient, title, priority or any other criteria. At S735, the retrieved emails are forwarded to the requester.

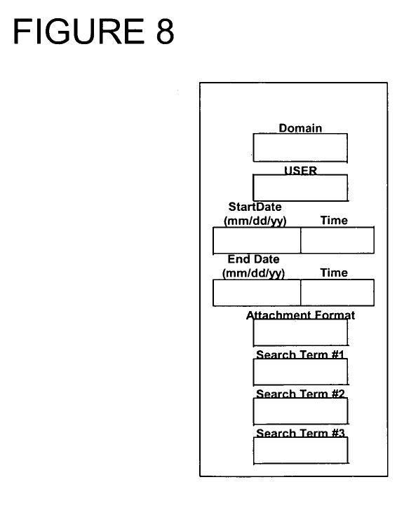

FIG. 8 shows an exemplary graphical user interface for entering information to search for archived emails. As an example, the graphical user interface shown in FIG. 8 may correspond to the search interface 135 shown in FIG. 2. The graphical user interface includes numerous search windows to enter information to be used to identify relevant emails. As shown, the search window includes entries for a start date and time and an end date and time. Accordingly, a requestor can request that a search of archived emails be performed for emails transmitted between the starting and ending dates and time.

The graphical user interface also includes a “domain” field, which can be used to specify a particular domain for senders and recipients of the emails to be retrieved. In this regard, many entities that provide email service have a dedicated internet domain that is part of the email address of each user. Accordingly, when an entity provides email service to clients, employees or customers, the emails for the entity can be easily segregated in an archive by grouping the emails with the entity's domain in the address.

The graphical user interface also includes a “user” field, which can be used to specify a particular user whose emails must be retrieved. Additionally, an attachment format may be specified, if the requestor is searching for emails that contain a particular form of attachment.

The titles and/or content of emails can be specified as searchable parameters using fields for search terms #1, search terms #2 and search terms #3. The search terms may be specified by any known method of searching, including boolean operators, wildcards, quotes, and any other type of formatting that can be used to search archived data.

Using the graphical user interface, the requestor can enter information that is used by the search engine module 136 to retrieve data from the archive 140. In an embodiment, the graphical user interface can search for emails to or from a particular type of address such as an internet protocol (IP) address, or user identification. Furthermore, the graphical user interface may provide a field to search for archived emails by the type of email client used to format the emails. The graphical user interface may also include fields to search for emails that were encrypted during the original transmission. In summary, the graphic interface may provide fields to enter search parameters for any parameter that can be used to distinguish emails from one another.

Although not shown, retrieved information may be saved as part of a summary or report, in order to provide accountability for the security of the archived emails. For example, a report may be generated every time an email is retrieved in response to a search of the archive 140. A session report may include the identification information of every retrieved email provided to a requester. As an example, the identification information may include the email's sender and recipient, date and time, IP addresses, title, size, attachments etc.

Additionally, the retrieved emails may be separately stored in a memory, e.g., in a temporary file of the record management system 130 for emails that match the parameters being sought. The retrieved information may be presented to the user via the search interface 135, until the user processes the information by, e.g., reviewing the email information and determining whether the email is relevant to the purpose of the search.

Accordingly, electronic communications are securely archived and managed using a secure record management system. The electronic communications are received in a format that is decryptable by the secure record management system, so that the electronic communications can be securely and efficiently archived and managed. If emails are received (or to be sent) in an author-specific or recipient-specific encrypted format, the copies are made after decryption is applied to the emails (for received emails) or before the encryption is applied to the emails (for emails to be sent). A corporation can archive the email copies in a common format that does not diminish an ability of the corporation to later read, search and/or otherwise analyze the email. Accordingly, the ability of a corporation to support court orders, company policies and company practices, is enhanced. As described above, an email client 110 interacts with a secure record management system 130. Incoming and outgoing mail is copied and transmitted to the record management system 130 from the email client 110. The record management system 130 analyzes and otherwise manages the emails, and archives the emails when appropriate. The system described herein reduces the risks and/or costs associated with conventional systems for data storage, while ensuring the ability of the company to support internal policies and public laws.

An exemplary use of record management of secured email may include management of an important group of users in a business. For example, emails from management employees of the business may need to be archived. However, when a business, such as a financial institution, has many management employees who each use their own encryption or security for communications, an archive of management emails can only be searched with great difficulty. According to the present invention, the electronic communications of numerous employees or clients can be centrally managed and archived using a common encryption system, without compromising the security of the company.

Of course, the record management of secured email does not need to archive all email from a computer. Moreover, the record management system 130 can provide management services for emails that are received from an email client 110 either encrypted or unencrypted. Furthermore, the email client 110 may be instructed to only forward emails from a predetermined set of users or computers to the record management system 130. Furthermore, the email client 110 may be instructed to only forward specified emails that meet predetermined criteria to the record management system 130.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, the email client 110 may be entirely embodied as a set of software instructions or modules distributed for execution on a client's computer 101 and/or an email server. Further, the computers 101, 199 may be computers on the same or different local area network, so long as the emails to and from computer 101 can be copied, encrypted and provided to the record management system 130. Additionally, the record management system 130 and archive 140 may be internal components of a local network for a single entity, such as a corporation. Of course, the record management system 130 and the archive 140 may also be provided as an external business service to multiple clients.

Additionally, the steps shown in the figures may be performed in a different order, or not be performed at all. For example, in FIG. 6, an email may be received at S600 in an unencrypted format, such that the email need not be decrypted to be categorized. Additionally, as explained herein, an email can be categorized, managed and archived without necessarily being decrypted. Accordingly, any method of searching, analyzing, monitoring and otherwise managing emails may fall within the purview of the invention.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for digital certificate format (e.g., X.509), packet switched network transmission (e.g., IP) and markup language protocols (e.g., HTML) represent examples of the state of the art. Such standards are periodically superseded by faster or more efficient equivalents having essentially the same functions. Accordingly, replacement standards and protocols having the same functions are considered equivalents.

What is claimed is:

1. A method for securely storing email using a secure record management system, comprising:
receiving an encrypted email at the secure record management system, the received email being a duplicated copy of a transmitted email and being decryptable by the secure record management system; and
processing the received email and providing the processed email to an archive for archiving.

2. The method for securely storing email of claim 1, further comprising:
decrypting the received email to obtain the transmitted email.

3. The method for securely storing email of claim 1, further comprising:
receiving, from a requester, a request to retrieve emails that match a searchable parameter;
searching the archive for emails that match the searchable parameter; and
retrieving from the archive at least one email that matches the searchable parameter.

4. The method for securely storing email of claim 1, further comprising:
generating information that identifies the received email.

5. A secure record management system for securely storing email, comprising:
an email receiver that receives an encrypted email, the received email being a duplicated copy of a transmitted email and being decryptable by the secure record management system; and
an email processor that processes the received email, wherein
the secure record management system provides the processed email to an archive for archiving.

6. The secure record management systems of claim 5, further comprising:
a decryptor that decrypts the received email to obtain the transmitted email.

7. The secure record management system of claim 5, further comprising:
a secure interface that receives, from a requestor, a request to retrieve emails that match a searchable parameter;
a search engine that searches the archive for emails that match the searchable parameter and that retrieves from the archive at least one email that matches the searchable parameter.

8. The secure record management system of claim 5, further comprising:
an information generator that generates information that identifies the received email.

9. A computer readable medium for securely storing email using a secure record management system, comprising:
an email receiving code segment that receives an encrypted email at the secure record management system, the received email being a duplicated copy of a transmitted email and being decryptable by the secure record management system; and
a processing code segment that processes the received email; and
a providing code segment that provides the processed email to an archive for archiving.

10. The computer readable medium of claim 9, further comprising:
a decrypting code segment that decrypts the received email to obtain the transmitted email.

11. The computer readable medium of claim 9, further comprising:
a request receiving code segment that receives, from a requestor, a request to retrieve emails that match a searchable parameter;
an archive searching code segment that searches the archive for emails that match the searchable parameter and that retrieves from the archive at least one email that matches the searchable parameter.

12. The computer readable medium of claim 9, further comprising:
an information generating code segment that generates information that identifies the received email.

13. A method for securely storing email using a secure record management system, comprising:
encrypting a duplicated copy of a transmitted email; and
sending the encrypted email to the secure record management system, the sent email being decryptable by the secure record management system, the sent email being processed by the secure record management system, and the processed email being provided to an archive for archiving.

14. The method for securely storing email of claim 13, wherein
the sent email is decrypted by the secure record management system to obtain the transmitted email.

15. The method for securely storing email of claim 13, wherein
the archive is searched for emails that match a searchable parameter, in response to receiving, from a requester, a request to retrieve emails that match the searchable parameter; and
at least one email that matches the searchable parameter is retrieved from the archive.

16. An email client that sends emails to a record management system for secure records storage, comprising:
an email encryptor that encrypts a duplicated copy of a transmitted email; and
an email sender that sends the encrypted email to the secure record management system, the encrypted email being decryptable by the secure record management system;
wherein the sent email is processed by the secure record management system and provided to an archive for archiving.

17. The email client of claim 16, wherein
the sent email is decrypted by the secure record management system to obtain the transmitted email.

18. The email client of claim 16, wherein
a search engine of the secure record management system searches the archive for emails that match a searchable parameter, in response to receiving, from a requester, a request to retrieve emails that match the searchable parameter; and
at least one email that matches the searchable parameter is retrieved.

19. A computer readable medium for securely storing email using a secure record management system, comprising:
an encrypting code segment that encrypts a duplicated copy of a transmitted email;
a sending code segment that sends the encrypted email to the secure record management system, the encrypted email being decryptable by the secure record management system;
wherein the sent email is processed by the secure record management system and provided to an archive for archiving.

20. The computer readable medium of claim 19, wherein
the sent email is decrypted by the secure record management system to obtain the transmitted email.

21. The computer readable medium of claim 20, wherein
a search engine of the secure record management system searches the archive for emails that match a searchable parameter, in response to receiving, from a requestor, a request to retrieve emails that match the searchable parameter; and
at least one email that matches the searchable parameter is retrieved.
